(19) United States
(12) Patent Application Publication
(10) Pub. No.: US 2012/0179517 A1
(43) Pub. Date: Jul. 12, 2012

(54) PRODUCT AUTHENTICATION DEVICES AND ASSOCIATED METHODS

(76) Inventors: Kam-Fai TANG, Costa Mesa, CA (US); Victor H. YOUNG, Union City, CA (US)

(21) Appl. No.: 12/987,001

(22) Filed: Jan. 7, 2011

(51) Int. Cl. G06Q 99/00; G06Q 30/00

(52) U.S. Cl. 705/14.4; 705/318

(57) ABSTRACT

A product authentication device for use with a consumer product includes an integrated circuit, a housing containing the integrated circuit, a coupling mechanism for detachably coupling the housing to the consumer product, and a communication interface for receiving an input from a transmitting device, wherein the integrated circuit is configured to use the input to generate an output in accordance with a predetermined algorithm for verifying an authenticity of the consumer product.

### FIELD

This application relates generally to product authentication.

### BACKGROUND

Counterfeit and fake product is now a worldwide rampaging problem that causes billions of monetary loss to producers. Such loss may be attributable from loss of sales to a producer, brand recognition damage, medical expenses due to sub-standard counterfeit products (such as, food and safety equipments etc.), and loss of life involving products such as fake drug and tainted food.

There are also indirect costs to the producers due to inaccurate inventory and supply chain planning, ineffective and incomplete product recall, false business intelligent reports base on distorted customer base information, incorrectly providing support or warranty service that costs resources, and incorrectly refusing support or warranty service that costs goodwill.

In addition to the above, counterfeit products may also create a life style problem for the consumers. In particular, a consumer may fear of getting a counterfeit product from an unreliable source. As such, the consumer may rather prefer to over pay a perceived respectable bigger retailer for a product, when in fact a smaller product provider may as well provide the same product at a less expensive price. Also, in some cases, a consumer may choose to repair a product instead of replace it, even though repairing may be more costly. This is because the consumer may fear that buying a replacement product may result in getting a counterfeit product that is inferior to an authentic product. In addition, fearing of getting a counterfeit product, a consumer may choose to pay additional travel cost to purchase from a distant respectable source. Furthermore, a consumer who unintentionally purchased a counterfeit product may not be able to get customer support from a company, which cannot confirm the validity of the product. Also, in some cases, the counterfeit product provider may also provide product and support information for the counterfeit product or genuine product. Thus, the consumer may be getting product and support information from an unreliable source.

For the foregoing reasons, applicants of the subject application determine that new systems and methods for determining an authenticity of a product would be desirable.

### SUMMARY

In accordance with some embodiments, a product authentication device for use with a consumer product includes an integrated circuit, a housing containing the integrated circuit, a coupling mechanism for detachably coupling the housing to the consumer product, and a communication interface for receiving an input from a transmitting device, wherein the integrated circuit is configured to use the input to generate an output in accordance with a predetermined algorithm for verifying an authenticity of the consumer product.

In accordance with other embodiments, a product authentication device includes an integrated circuit, a housing containing the integrated circuit, a coupling mechanism for detachably coupling the housing to the consumer product, and a communication interface for communication with a data source, wherein the integrated circuit is configured to generate an output in accordance with a predetermined algorithm for verifying an authenticity of the consumer product.

In accordance with other embodiments, a method for verifying an authenticity of a consumer product includes providing a module with a consumer product, the module being detachably coupled to the consumer product, using the module to access a web page to obtain an input, and using the input to generate an output in accordance with a predetermined algorithm for verifying the authenticity of the consumer product.

In accordance with other embodiments, a product authentication device for use with a consumer product includes a circuit configured to provide information for determining an authenticity of the consumer product, a housing containing the circuit, a first communication interface coupled to the circuit, a second communication interface for providing a tracking signal, and a shield for covering at least a portion of the housing, the shield having a first portion for blocking RF signal, and a second portion through which the RF signal can transmit therethrough.

In accordance with some embodiments, a method for use in a process to authenticate a consumer product includes receiving a serial number from a device through a network, wherein the device is configured to detachably couple to the consumer product, determining a validity of the serial number, transmitting a number to the device through the network, using the number to generate a reference verification number in accordance with a predetermined algorithm, receiving a calculated verification number from the device through the network, and comparing the calculated verification number with the reference verification number to determine whether the consumer product is authentic.

In accordance with other embodiments, a system for use in a process to authenticate a consumer product includes a processor that is configured for receiving a serial number from a device through a network, wherein the device is configured to detachably couple to the consumer product, determining a validity of the serial number, transmitting a number to the device through the network, using the number to generate a reference verification number in accordance with a predetermined algorithm, receiving a calculated verification number from the device through the network, and comparing the calculated verification number with the reference verification number to determine whether the consumer product is authentic.

In accordance with other embodiments, a computer program product includes a non-transitory medium storing a set of instructions, an execution of which will cause a method to be performed, wherein the set of instructions comprises instruction for receiving a serial number from a device through a network, wherein the device is configured to detachably couple to the consumer product, instruction for determining a validity of the serial number, instruction for transmitting a number to the device through the network, instruction for using the number to generate a reference verification number in accordance with a predetermined algorithm, instruction for receiving a calculated verification number from the device through the network, and instruction for comparing the calculated verification number with the reference verification number to determine whether the consumer product is authentic.

In accordance with other embodiments, a method for use in a process to authenticate a consumer product includes receiving information regarding a consumer product, wherein the information is associated with a serial number in a module that is configured to detachably couple to the consumer product, updating a table in a database, wherein in the table, the serial number is associated with the information regarding the consumer product, performing a product authenticity verification process using the serial number from the database, and providing the information regarding the consumer product when a result of the product authenticity verification process indicates that the consumer product to which the module is configured to detachably couple is authentic.

In accordance with other embodiments, a system for use in a process to authenticate a consumer product includes a processor that is configured for receiving information regarding a consumer product, wherein the information is associated with a serial number in a module that is configured to detachably couple to the consumer product, updating a table in a database, wherein in the table, the serial number is associated with the information regarding the consumer product, performing a product authenticity verification process using the serial number from the database, and providing the information regarding the consumer product when a result of the product authenticity verification process indicates that the consumer product to which the module is configured to detachably couple is authentic.

In accordance with other embodiments, a computer program product includes a non-transitory medium storing a set of instructions, an execution of which will cause a method to be performed, wherein the set of instructions comprises instruction for receiving information regarding a consumer product, wherein the information is associated with a serial number in a module that is configured to detachably couple to the consumer product, instruction for updating a table in a database, wherein in the table, the serial number is associated with the information regarding the consumer product, instruction for performing a product authenticity verification process using the serial number from the database, and instruction for providing the information regarding the consumer product when a result of the product authenticity verification process indicates that the consumer product to which the module is configured to detachably couple is authentic.

In accordance with other embodiments, a method that involves product authentication includes receiving a serial number from a device through a network, using the serial number in a product authentication process to verify an authenticity of a consumer product that is associated with the device, receiving information regarding a purchaser of the consumer product during the product authentication process, and compiling marketing data using the received information.

In accordance with other embodiments, a system for product authentication includes a processor that is configured for receiving a serial number from a device through a network, using the serial number in a product authentication process to verify an authenticity of a consumer product that is associated with the device, receiving information regarding a purchaser of the consumer product during the product authentication process, and compiling marketing data using the received information.

In accordance with other embodiments, a computer program product includes a non-transitory medium storing a set of instructions, an execution of which will cause a method to be performed, wherein the set of instructions comprises instruction for receiving a serial number from a device through a network, instruction for using the serial number in a product authentication process to verify an authenticity of a consumer product that is associated with the device, instruction for receiving information regarding a purchaser of the consumer product during the product authentication process, and instruction for compiling marketing data using the received information.

In accordance with some embodiments, a method that involves product authentication includes associating a serial number of a device with a first consumer product, thereby allowing an authenticity of the first consumer product to be verified using the device, determining whether the first consumer product is authentic using the serial number, and associating the serial number of the device with a second consumer product after the first consumer product is sold and after the device has been returned for recycling, thereby allowing an authenticity of the second consumer product to be verified using the device.

In accordance with other embodiments, a system for product authentication includes a processor that is configured for associating a serial number of a device with a first consumer product, thereby allowing an authenticity of the first consumer product to be verified using the device, determining whether the first consumer product is authentic using the serial number, and associating the serial number of the device with a second consumer product after the first consumer product is sold and after the device has been returned for recycling, thereby allowing an authenticity of the second consumer product to be verified using the device.

In accordance with other embodiments, a computer program product includes a non-transitory medium storing a set of instructions, an execution of which will cause a method to be performed, wherein the set of instructions comprises instruction for associating a serial number of a device with a first consumer product, thereby allowing an authenticity of the first consumer product to be verified using the device, instruction for determining whether the first consumer product is authentic using the serial number, and instruction for associating the serial number of the device with a second consumer product after the first consumer product is sold and after the device has been returned for recycling, thereby allowing an authenticity of the second consumer product to be verified using the device.

Other and further aspects and features will be evident from reading the following detailed description of the embodiments, which are intended to illustrate, not limit, the invention.

### BRIEF DESCRIPTION OF THE DRAWINGS

The drawings illustrate the design and utility of embodiments, in which similar elements are referred to by common reference numerals. These drawings are not necessarily drawn to scale. In order to better appreciate how the above-recited and other advantages and objects are obtained, a more particular description of the embodiments will be rendered, which are illustrated in the accompanying drawings. These drawings depict only typical embodiments and are not therefore to be considered limiting of its scope.

FIG. 1 illustrates a device for authentication of a product in accordance with some embodiments;

FIG. 2 illustrates a flow diagram for an authentication process in accordance with some embodiments;

FIG. 2A illustrates a method for programming a secret code into a chip in accordance with some embodiments;

FIG. 3 illustrates a method of authenticating a product in accordance with some embodiments;

FIG. 4 illustrates an example of a table that may be stored in a database of an authentication service provider in accordance with some embodiments;

FIG. 5 is a flow diagram illustrating different services that may be provided by the authentication service provider in accordance with some embodiments;

FIG. 6 illustrates another device for authentication a product in accordance with other embodiments;

FIG. 7 illustrates another device for authentication a product in accordance with other embodiments; and

FIG. 8 is a block diagram of a computer system architecture, with which embodiments described herein may be implemented.

### DESCRIPTION OF THE EMBODIMENTS

Various embodiments are described hereinafter with reference to the figures. It should be noted that the figures are not drawn to scale and that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated.

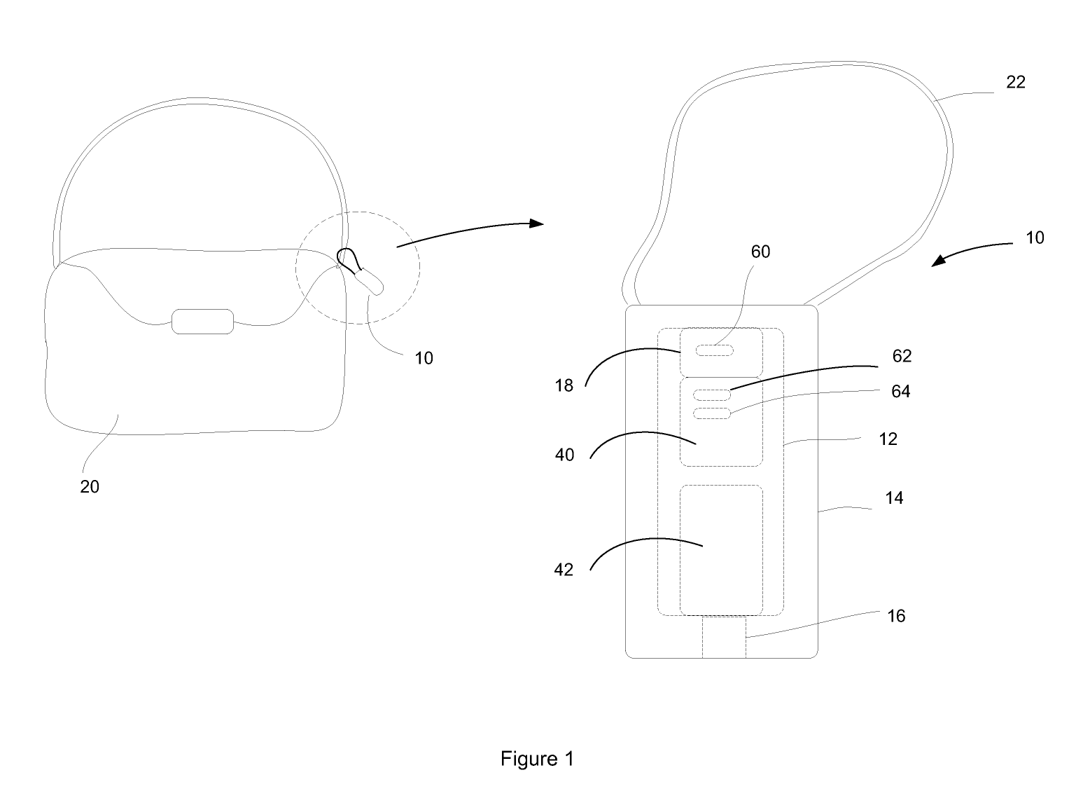

FIG. 1 illustrates a product authentication device 10 in accordance with some embodiments. In some embodiments, the product authentication device 10 may be implemented as a tag, in which case, the product authentication device 10 may also be called a product authentication tag (PAT). However, in other embodiments, the product authentication device 10 may have other configurations, and may not be implemented as a tag. In the illustrated embodiments, the product authentication device 10 includes an integrated circuit 12 that is housed in a housing 14. The product authentication device 10 also includes a communication interface 16 that is configured to communicate with a data source. The product authentication device 10 is for coupling with a product 20 during use. In the illustrated example, the product 20 is a handbag. In other examples, the product 20 may be different consumer products, such as medicine, food (e.g., baby food), clothing, jewelry, appliance, electronic device, etc. Thus, as used in this specification, the term “product” or similar terms, such as “consumer product”, may refer to consumable product or non-consumable product.

Also, in the illustrated embodiments, the product authentication device 10 includes a coupling mechanism 22 for coupling with a product 20. The coupling mechanism 22 is illustrated as a string in the illustrated embodiments. In other embodiments, the coupling mechanism 22 may be other mechanisms, such as a Velcro, a button, an adhesive, a clip, or any of other devices that is capable of detachably securing the product authentication device 10 to the product 20. Also, in further embodiments, the coupling mechanism 22 may be a feature of the product 20 (e.g., a surface of the housing 14), which provides some friction between the product authentication device 10 and the product 20. In such cases, the product authentication device 10 may simply be placed in a pocket or storage area inside the handbag (in the example in which the product 20 is a handbag). In this example, the friction between the device 10 and the product 20 may be considered as the coupling mechanism 22 (even though the friction is not the main feature that keeps the device 10 and the product 20 together). Alternatively, the pocket or storage area in the handbag (e.g., or any feature of the product 20) may be considered as the coupling mechanism 22. In further alternative, the friction between the device 10 and the product 20, and the pocket of the handbag, together may be considered as the coupling mechanism 22. In another example in which the coupling mechanism 22 is a feature of the product authentication product 10, the product authentication device 10 may be placed inside a container (e.g., a can of infant formula) of the product 20. In such cases, the housing 14 may be wrapped with a protective material to prevent the infant formula from chemically reacting with any part(s) (e.g., electrical contact(s) of the communication interface 16 and/or the material of the housing 14) of the device 10. The friction between the device 10 or the protective material and the infant formula may be considered as the coupling mechanism 22. In still another example, if the product 20 has a package container (e.g., a paper box), the product authentication device 10 may be placed inside the container, or be placed outside the container but held in place by a shrinkage-wrap. In such cases, friction between any part(s) of the device 10 and the product 20 may be considered as the coupling mechanism 22. Also, in further embodiments, the coupling mechanism 22 may be a part of the product 20, instead of, or in addition to, being a part of the product authentication device 10.

Allowing the product authentication device 10 to be detachably coupled to the consumer product 20 is advantageous because it allows the device 10 to be used with any one of different types of consumer products 20. For example, in some embodiments, the device 10 may be used with non-electronic consumer product 20. In other embodiments, the device 10 may be used with electronic consumer product 20. In such cases, because the device 10 itself may be detachably coupled to the electronic consumer product 20, the device 10 does not need to be electronically integrated with the electronic components of the electronic consumer product 20. Thus, the detachably coupling feature of the device 10 allows a product producer to implement a product authentication feature into its products without the need to change the design of the products, and without the need to spend excessive resources for integrating (e.g., permanently securing) the device 10 with component(s) of the product.

The communication interface 16 allows the product authentication device 10 to communicate with an authentication service provider (ASP), which may be a secured server in some embodiments. As used in this specification, the term “authentication service provider” or similar terms, such as “ASP”, is not limited to a server, and may refer to different devices/modules in different embodiments. For example, the ASP may be a computer, a server, or any of other electronic devices (such as a phone, a PDA, etc.) that is capable of receiving and transmitting information. In some embodiments, the communication interface 16 may be an electrical port which provides a connection for internet access. For examples, the communication interface may be a universal serial bus (USB), a radio frequency device for communicating with another device using radio frequency, an optical device for communicating with another device using optical signals, or any of other types of communication devices.

The integrated circuit 12 is configured to generate an output based on one or more inputs received therein, wherein the output may be used to verify an authenticity of the product 20. In the illustrated embodiments, the integrated circuit 12 includes an authentication circuit 40 and a controller circuit 42 (e.g., a microcontroller circuit). The controller circuit 42 is configured to receive data from the communication interface 16, and pass the data to the authentication circuit 40. The controller circuit 42 may also receive data from the authentication circuit 40, and pass the data to the communication interface 16. The controller circuit 42 may be configured to perform other functions, such as translates electrical signal(s) from the communication interface 16, and then outputs the translated signal(s) to the authentication chip 40. Similarly, the controller circuit 42 may translate signal(s) in the reverse path. When the controller circuit 42 receives signals from one interface, it would determine if it is a valid command. In some embodiments, if the signal amplitude and timing conform to the specification, and if the received command is valid (e.g., belongs to one of the available commands in a command set), then it may reformat the signal to tailor it to the receiving interface. Otherwise, it may discard it or ignore the input. Although the authentication circuit 40, the controller circuit 42, and the communication interface 16 are illustrated as separate components, in other embodiments, the communication interface 16 may be a part of the controller circuit 42 or the authentication circuit 40.

In one implementation, the circuit 12 may include chip AT88SA102S (available from Atmel) as the authentication chip 40, and chip ATtiny85 (also available from Atmel) as the controller chip 42. In this example, the ATtiny85 microcontroller chip 42 is configured to communicate between the AT88SA102S authentication chip 40 and communication interface 16. As the AT88SA102S chip does not have a communication interface (e.g., it has no USB connector), the ATtiny85 controller chip 42 provides the communication interface 16 (e.g., USB interface), which communicates with the ASP, and pass information between the ASP and the authentication chip 40. The communication interface 16 is configured to detachably couple to a device with Internet access capability. Such device may be a smartphone (e.g., with 3G network), a PDA, a computer, etc. In some embodiments, the AT88SA102S and the ATtiny85 chips may be surface mounted onto a printed circuit board (PCB). The PCB with the two chips is then encapsulated with plastic resin to form the housing 14 with only the USB interface electrical contacts exposed. In other embodiments, the circuit 12 (or at least a part of the circuit 12) may be implemented using AT88SA102S chip available from Atmel. The product authentication device 10 is then electrically tested to make sure the device 10 is working properly.

In the above embodiments, the circuit 12 is described as having two chips that form an integrated circuit. In other embodiments, the circuit 12 may be implemented using a single chip. Also, in other embodiments, the circuit 12 may have more than two integrated circuits (e.g., chips) electrically connected to provide the same functions (wherein the combined circuits may also be considered an integrated circuit).

As shown in FIG. 1, the product authentication device 10 further includes a medium 18 for storing data. The medium 18 may be a volatile or non-volatile medium. In some embodiments, the medium 18 may be a non-transitory medium. Also, in other embodiments, the medium 18 may include two or more memory units, wherein the memory units may be volatile media or non-volatile media. In further embodiments, the medium 18 may include two or more memory units with at least one memory unit being a volatile medium, and at least one other memory unit being a non-volatile medium.

In the illustrated embodiments, the circuit 12 is mass manufactured but each circuit 12 will have a unique serial number 60 that is provided by the manufacturer of the circuit 12. The serial number may be 48 bits long in some embodiments. In other embodiments, the serial number 60 may be less than 48 bits or longer than 48 bits. This serial number 60 cannot be changed or reprogrammed. During a manufacturing process, the integrated circuit manufacturer also provides a unique passcode (key) 62 in each circuit 12, wherein the key 62 is customer specific. The key 62 may be 256 bits long. In other embodiments, the key 62 may be less than 256 bits or longer than 256 bits. In one implementation, the key 62 may be a 256 bit personalization key (e.g., achieved using metal layer) provided by the circuit 12 manufacturer to its customer, wherein the personalization key cannot be read outside the chip. In one implementation, an interconnection layer (metal layer) is provided in the circuit 12 manufacturing process to set the key 62, which provides electrical connection among two or more electrical nodes based on a specific mask design. It may be an aluminum alloy with a thickness of 600 nm to 1200 nm, and metal line width ranges from 180 nm to 100 um. The key 62 is provided in the circuit 12 by the circuit manufacture to safe guard and use it. In some cases, the key 62 allows the ASP to verify a specific circuit 12 with the circuit manufacturer. In the illustrated embodiments, the circuit 12 also has a secret code 64 programmed therein. In the illustrated embodiments, the secret code 64 is programmed into the circuit 12 by the ASP or a contract programmer for the ASP that is different from the circuit manufacturer. Such arrangement has the benefit of making the device 10 more difficult to copy, and/or preventing unauthorized circuits 12 (e.g., circuits 12 that are stolen from the circuit manufacturer, or circuits 12 that are illegally shipped from the circuit manufacturer, such as to another company that is not associated with the ASP) from the circuit manufacturer from being used. In other embodiments, the secret code 64 may also be programmed by the circuit manufacturer that provides the circuit 12. Both the key 62 and the secret code 64 cannot be read out from the circuit 12 during use. Although the serial number 60 is illustrated as being stored in the medium 18, in other embodiments, the serial number 60 may be physically implemented in the chip 40, such as by using fuses, using metal layer(s), etc. Also, although the key 62 and the secret code 64 are illustrated as being physically implemented in the chip 40, in other embodiments, either or both of these may be stored in the medium 18, or in another medium that is coupled to the chip 40.

In one implementation, part of the serial number 60 (e.g., 16 bits) may be hard-coded in a ROM (read only memory), and the rest of the 32 bit serial number bits may be implemented using one time programmable fuses, programmed by the circuit manufacturer. This 48 bit serial number 60 can always be read out in some embodiments. The key 62, which has 256 bits in the above example, may be hard-coded with metal layer. The metal layer is achieved using a specific metal mask pattern, and therefore the key 62 is coded during the semiconductor manufacturing process. They key 62 cannot be modified after the circuit 12 is fabricated. The secret code 64 has 64 bits in the above example. The secret code 64 may be implemented using one time programmable fuses. The programmable fuse is similar to an electrical fuse in that once it is burnt, it cannot be reconnected. The AT88SA102S secret fuses are programmed by the user which in this case is the ASP or its contract programmer.

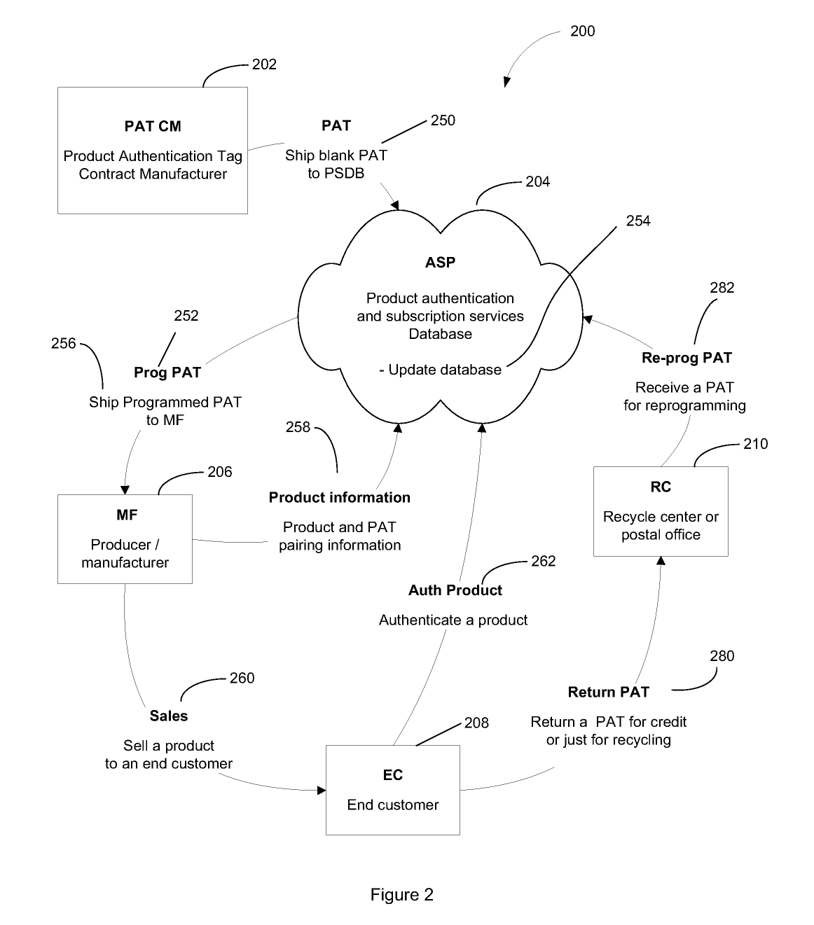

FIG. 2 illustrates a flow diagram 200 for an authentication process in accordance with some embodiments. First a manufacturer 202 of the product authentication device 10 makes the product authentication device 10 and sends it to the ASP 204 (Step 250). The product authentication device 10 that is sent to the ASP 204 will have the unique serial number 60 and the key 62 stored therein.

The ASP 204, upon receiving the product authentication device 10, will have the secret code 64 programmed into the device 10 (Step 252). The programming of the secret code 64 into the device 10 may be performed by the ASP 204, or by an agent (e.g., contract programmer) of the ASP 204. In some embodiments, the programming of the secret code 64 may be done in a secured manner. FIG. 2A illustrates an example of a method 270 for programming the secret code 64 in a secured manner in accordance with some embodiments. First, the ASP 204 determines the secret code 64 (Step 271).

The secret code 64 may be generated by the ASP 204 (or its agent) using different techniques in different embodiments. In the illustrated embodiments, the secret code 64 may be generated using the serial number 60. In such cases, based on the serial numbers provided by the device manufacturer 202 for the different devices 10, the ASP 204 may run an algorithm to determine the secret codes 64 for the respective different devices 10 with different corresponding serial numbers 60. In one implementation, the ASP 204 may provide a key, and then concatenate the serial number 60 of a device 10 to the key in order to calculate a hash value in accordance with a hashing algorithm. The ASP 204 may then use part (or all) of the hash value as the secret code 64. For a second device 10, the ASP 204 may use the same key (or a different key in another embodiment), and apply that key to the serial number 60 of the second device 10 to calculate a second hash value for the second device 10. The ASP 204 may then use part (or all) of the second hash value as the secret code 64 for the second device 10. Because the different devices 10 have different serial numbers 60, the resulting secret codes 64 for the different devices 10 will be different. In other embodiments, the secret code 64 may be determined using other techniques.

Next the ASP 204 determines an input seed 800 (Step 272). The input seed 800 may be a code or a passphrase that is randomly picked by the ASP 204.

Next, using the secret code 64 and the key 62, the ASP 204 determines a fuse burn map 802 (Step 273). The fuse burn map 802 is a map configured to inform the circuit 12 which fuses to burn (programmed). In one implementation, each fuse in the circuit has a status that represents the secret code bit, wherein an un-burn fuse has a value of 1, and a burnt fuse has a logical value of 0. In the illustrated embodiments, the circuit 12 has 64 fuses representing the 64 bit secret code 64. In other embodiments, the number of fuses may be different from 64. In the illustrated embodiments, the ASP 204 uses the key 62 and the input seed 800 as inputs, and hash out a decryption digest 804 (or fuse burn map key 804) (Step 274). In some embodiments, the hashing may be performed using algorithm SHA256. In other embodiments, the hashing may be performed using other algorithms. The ASP 204 would then use this decryption digest 804 to generate the fuse burn map 802 to match the secret code 64 (Step 275). In some embodiments, the fuse burn map 802 is determined based on the equation:

Secret code 64=decryption digest 804 XOR fuse burn map 802 (Eqn 1)

Which implies that: fuse burn map 802=decryption digest 804 XOR secret code 64

Next, the ASP 204 transmits the input seed 800 and the fuse burn map 802 to the circuit 12 (Step 276). The circuit 12 contains the key 62 in the authentication chip 40, but the key 62 cannot be read out. In the illustrated embodiments, when programming the secret code 64 into the circuit 12, the controller 42 receives a command from the ASP 204 (e.g., through the communication interface 16), and then translates it to tell the authentication chip 40 what to do.

After receiving the command from the controller 42, the authentication chip 40 performs fuse burning to program the secret code 64 in the circuit 12 (Step 278). In the illustrated embodiments, the authentication chip 40 is configured to use the key 62 which is stored inside the authentication chip 40, and the input seed 800, as inputs and hash out a decryption digest 806 (or fuse burn map key 806) internally inside the authentication chip 40 using the same hashing algorithm used by the ASP 204 (Step 280). In some embodiments, the hashing may be performed using algorithm SHA256. In other embodiments, the hashing may be performed using other algorithms. The decryption digest 806 calculated by the chip 40 should have the same value as that of decryption digest 804 calculated by the ASP 204 since the inputs and algorithms are the same. The decryption digest 806 cannot be read out from the authentication chip 40. It is a transitory value to be used internally by the authentication chip 40.

Next, the authentication chip 40 uses the decryption digest 806 to calculate the actual or final fuse burn map 810 based on the fuse burn map 802 (Step 282). In some embodiments, the final fuse burn map 810 may be determined based on the equation:

Final fuse burn map 810=decryption digest 806 XOR fuse burn map 802

Since decryption digest 806 is equal to the decryption digest 804, the above equation becomes:
Final fuse burn map 810=decryption digest 804 XOR fuse burn map 802 Base on Eqn 1, the final fuse burn map 810 is equal to the secret code 64. In the illustrated embodiments, the Final fuse burn map 810 is transitory and cannot be read out from the Authentication chip 40 so as to protect its secrecy.

The authentication chip 40 would then use the final fuse burn map 810 to burn the fuses in the chip 40 to thereby program the secret code 64 (Step 284). As illustrated in the above embodiments, the secret code 64 is programmed by passing only the pass phrase 800 and the fuse burn map 802 to the circuit 12. Thus, nothing about the secret code 64 is revealed to the contract programmer. The contract programmer needs to know only the input seed 800 and the fuse burn map 802 to program the secret code 64 into the circuit 12. However, the contract programmer would have no idea or will have an extremely difficult time to figure out the final fuse burn map 810 which indicates which secret fuses to burn or program. In order words, the contract programmer cannot figure out the secret code 64.

Returning to FIG. 2, in the illustrated embodiments, when the product authentication devices 10 are received by the ASP 204, the ASP 204 also updates the secure central data base (Step 254). Stringent control procedures may be adopted to make sure that no one person can access, hack, corrupt, or destroy the central data base which contains all the attributes of the product authentication devices 10, as well as their associated product information if any.

With the unique serial number 60, and a set of unreadable key 62 and secret code 64 inside the product authentication device 10, the device 10 is ready to use. After a product provider 206 (e.g., manufacturer of the product 20) has ordered a number of product authentication devices 10 to use with their products 20 from the ASP 204, the ASP 204 then sends the equivalent amount of devices 10 to the product provider 206, updates its data base using the serial numbers 60 of the devices 10 from the inventory, and sends the products 10 to the product provider 206 (Step 256). In some embodiments, the updating of the data base of the ASP 204 may involve updating a table to indicate that the devices 10 with certain respective serial numbers 60 have been sent to a particular product provider 206. It should be noted that as used in this specification, the term “provider” or similar terms, such as “product provider” is not limited to a business entity (e.g., company, person, etc.) that “manufactures” a product, and may refer to any business entity that provides a product. For example, in some embodiments, the product provider may be an agricultural company that grows or produce food. In other embodiments, the product provider may be a painter who creates paintings. In further embodiments, the product provider 202 may be a company or person that buys the product 20 and resell the product 20.

The product provider 206 may be required by the ASP 204 to provide product data for the products 20 that will be sold with the respective devices 10 to the ASP 204 (Step 258). By means of non-limiting examples, the product data may include one or more of make of the product, model identification of the product, color of the product, weight of the product, manufacture date, shelf life of the product, instruction of use for the product, warranty information for the product, etc. Also, in one implementation, the product data may be transmitted from the product provider 206 to the ASP 204 in table form. The product provider 206 would then send the product data to the ASP 204 using a secured transmission technique. For example, in some embodiments, the product provider 206 may encode the product data using a public encryption key provided by the ASP 204. The ASP 204, upon receiving the encrypted product data, decrypts it with its private key. The ASP 204 then updates its database with this product data.

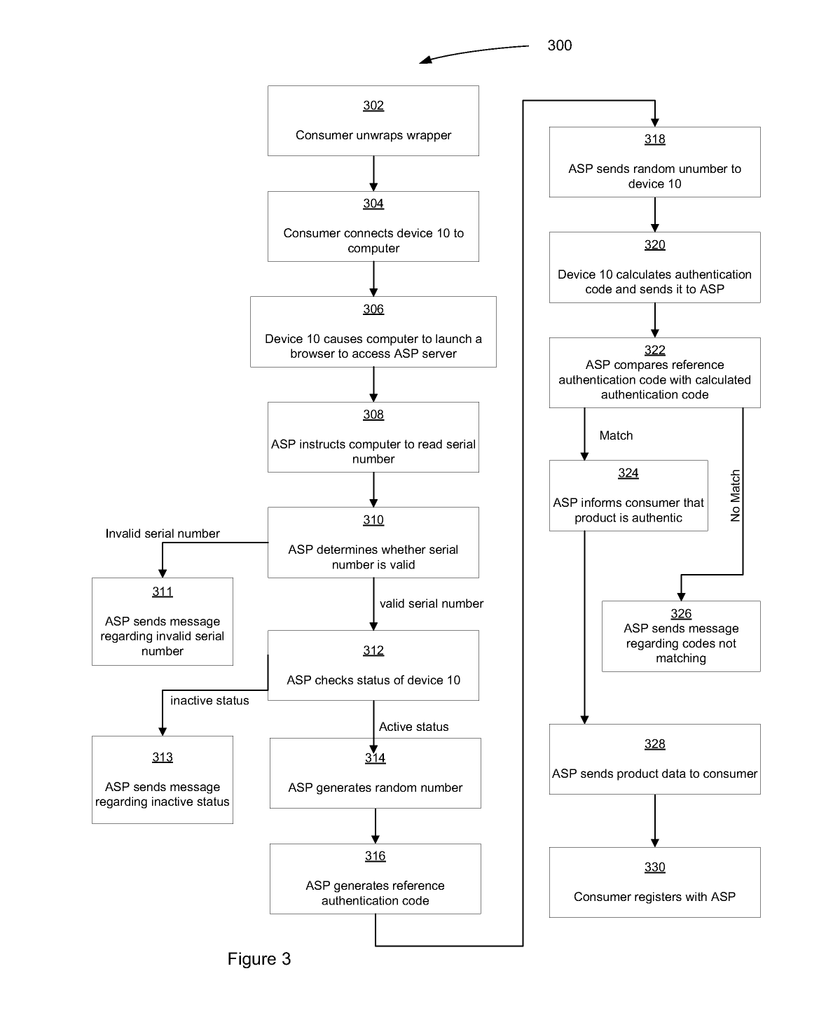

FIG. 4 illustrates an example of a table 400 that may be stored at the database of the ASP 204. In the illustrated embodiments, the table 400 includes a first column 402 listing all of the available serial numbers 60, a second column 404 indicating whether devices 10 corresponding to the respective serial numbers 60 have been sent to product providers 206, a third column 406 indicating whether the devices 10 corresponding to the different serial numbers 60 are active. In the illustrated embodiments, the device 10 may be considered “active” when the ASP 204 has received confirmation from the product provider 60 that the device 10 has been used with a particular product 20. Also, as shown in the figure, the table 400 includes a fourth column 408 and a fifth column 410 listing the keys 62 and the secret codes 64, respectively, for the corresponding serial numbers 60. Although the key 62 is illustrated to have different values in the example, in other embodiments, the values for the key 62 may be all the same. Also, in further embodiments, the key 62 may have different values based on different manufacturers (components from the same manufacturer will have the same key value), geographical region (components at the same country will have the same key value), etc. The table 400 further includes a sixth column 412 listing product data that correspond with respective serial numbers 60, wherein the product data are information regarding the product 20 provided previously by the product provider 60. Although one column is shown, in other embodiments, the table 400 may include a plurality of columns for storing different product data (e.g., one column for product identification, one column for model of the product, one column for the manufacture date, etc.). It should be noted that the format of the table 400 is not limited to that shown in the example, and that in other embodiments, the table 400 may have other formats. For example, in other embodiments, the different types of data may be arranged in different rows instead of in different columns. Also, in other embodiments, the table 400 may be implemented using more than one tables that are associated (e.g., linked) with each other.

After the ASP 204 has updated its database, the corresponding device 10 will become active and ready for product authentication. If there are extra product authentication devices 10 which the product provider 60 could not use, the product provider 60 is required to update the ASP 204 by either returning the unused devices 10 to the ASP 204, or to keep them for their next batch of products.

After a consumer 208 buys the product 20 from a store (Step 260), the consumer 208 may use the product authentication device 10 that is coupled to the product 20 for determining the authenticity of the product 20. In some embodiments, the packaging material of the product 20 may have instruction for instructing the consumer 208 how to use the product authentication device 10 to authenticate the product 20. In other embodiments, the instruction of use for the product 20 may also include instruction for using the product authentication device 20. In further embodiments, a separate insert may be coupled to the product 20 for providing the instruction for using the product authentication device 10. In still further embodiments, the instruction for using the product authentication device 10 may be provided on a packaging (if any) of the product authentication device 10, on a sticker that is attached to the device 10, or on a tag that is coupled to the product authentication device 10. In further embodiments, the instruction for using the product authentication device 10 may be provided by a person, a flyer, or a poster at the store.

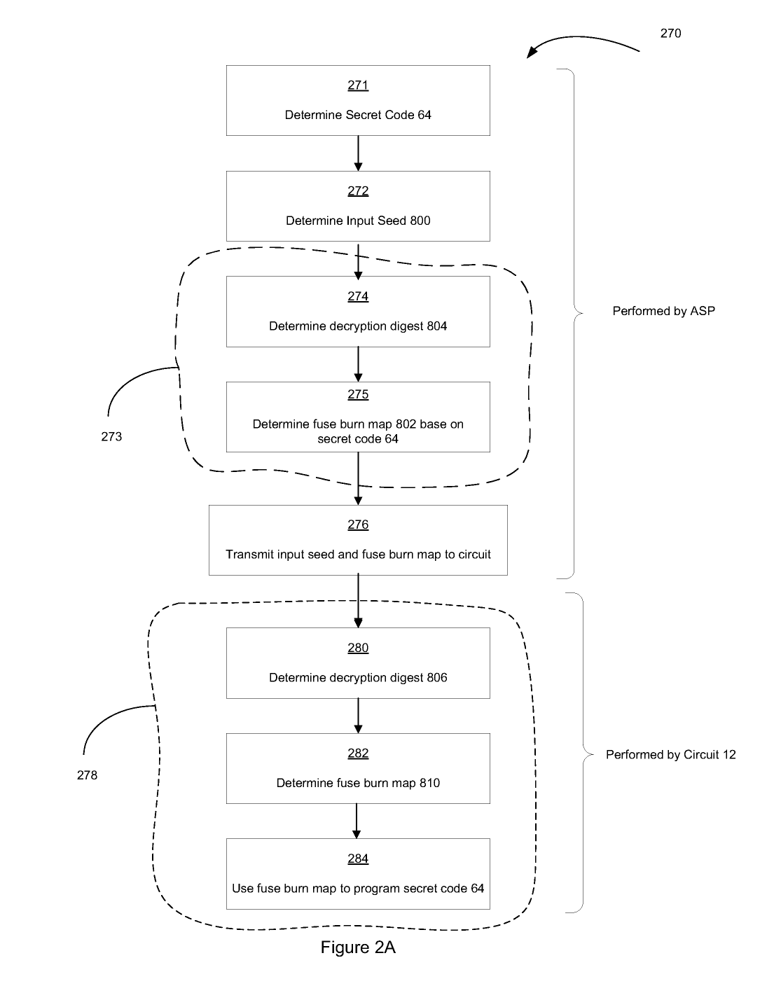

Referring to FIG. 3, in one method 300 of using the product authentication device 10, the consumer 208 first un-wraps any wrapper (if any) from the product authentication device 10 (Step 302). If the product authentication device 10 does not have any wrapper, then step 302 may be omitted.

The consumer 208 then detachably connects the product authentication device 10 with a computer using the communication interface 16 (Step 304). The computer may be located at the store at which the product 20 is purchased by the consumer 208. Alternatively, the computer may be a computer owns by the consumer 208, or any other computer that is accessible by the consumer 208. In the example in which the communication interface 16 is a USB connector, the device 10 may be plugged into the USB port of the computer. In other embodiments, the communication interface 16 may be other types of communication connector.

The computer detects the presence of the product authentication device 10, which causes the computer to automatically launch a browser and invoke a secure internet access using the browser to the server of the ASP 204 (Step 306). Techniques for causing the computer to automatically launch a browser to access a remote server upon an insertion of a device at the USB port of the computer is known in the art, and will not be described in detail.

The ASP 204, upon receiving a request from the computer to access its database, provides a user interface at the browser, and asks the consumer 208 through the user interface if the consumer 208 wants to authenticate the product 20 that corresponds with the product authentication device 10. After the consumer 208 affirms the question, the ASP 204 then instructs the computer to read the serial number 60 of the product authentication device 10 via a software driver through a secure socket layer (Step 308). The serial number 60 is read from the product authentication device 10 by the computer, and is transmitted from the computer to the ASP 204 through the Internet.

After receiving the unique serial number 60 of the product authentication device 10, the ASP 204 checks its data base to determine whether the serial number 60 is valid (Step 310). If the ASP 204 could not locate the serial number 60 from its database, then the ASP 204 would send a message through the Internet to the computer to inform the consumer 208 that the serial number 60 of the product authentication device 10 is invalid and/or that the product 20 may not be authentic (Step 311).

If the serial number 60 is valid, the ASP 204 then checks the status of the product authentication device 10 that corresponds with the received serial number 60 (Step 312). If the ASP 204 determines that the status of the device 10 corresponding with the serial number 60 is “inactive”, then the ASP 204 would send a message through the Internet to the computer to inform the consumer 208 that the product authentication device 10 is invalid and/or that the product 20 may not be authentic (Step 313).

If the ASP 204 determines that the status of the device 10 corresponding with the serial number 60 is “active”, the ASP 204 would then generate a random number 70 (Step 314). The random number 70 may be generated using any known random number generation algorithm.

The ASP 204 would use this random number 70, the serial number 60, and its corresponding secret code 64 and key 62 which are stored in the database of the ASP 204, to generate a reference authenticate code 72 based on a predetermined algorithm (Step 316). For example, the algorithm may be a hashing algorithm, such as the SHA-256 hashing algorithm.

The ASP 204 would then “challenge” the product authentication device 10 by sending the same random number 70 to the product authentication device 10 (Step 318). In the illustrated embodiments, the random number 70 is transmitted through the Internet to the computer to which the product authentication device 10 is coupled.

Upon receiving the challenge command with the random number 70 from the ASP 204, the product authentication device 10 initiates a computation based on the random number 70 from the ASP 204, and the serial number 60, the secret code 64, and the key 62 in the product authentication device 10, using the same hashing algorithm to obtain a calculated authentication code 80 (Step 320). The calculated authentication code 80 from the device 10 is then sent to the ASP 204 through the Internet using the communication interface 16.

The ASP 204 compares the reference authentication code 72 with the calculated authentication code 80 from the product authentication device 10 (Step 322). If the codes 72, 80 match, then the ASP 204 determines that the product authentication device 10 and/or the associated product 20 is genuine, and transmits a message to the computer that the consumer 208 is using through the Internet to indicate that the product authentication device 10 and/or the associated product 20 is genuine (Step 324). If the codes 72, 80 do not match, then the ASP 204 determines that the product authentication device 10 and/or the associated product 20 is not genuine, and transmits a message to the computer that the consumer 208 is using through the Internet to indicate that the product authentication device 10 and/or the associated product 20 is not genuine (Step 326). In any of the embodiments, the information transmitted from the ASP 204 to the computer being used by the consumer 208 may be displayed on a screen coupled to the computer. In further embodiments, the ASP 204 may also transmit a signal to the computer to cause the computer to emit an audio signal for indicating whether the device 10 and/or the associated product 20 is genuine or not.

If the product 20 and/or the device 10 associated with the product 20 is determined to be genuine, the ASP 204 looks up its data base on the corresponding product information (which was previously provided to the ASP 204 by the product provider 206) and presents it to the consumer 208 through the Internet (Step 328). For example, the ASP 204 may transmits the product information, such as product description, make, model, lot number, manufacture date, instruction of use, updated warning, recall instruction, etc., to the computer that the consumer 208 is using through the Internet. The computer then displays the product information on a screen for the consumer 208 to view. In other embodiments, the act of providing product information to the consumer 208 is optional, and the method 300 may not include step 328.

Also, if the product 20 and/or the device 10 associated with the product 20 is determined to be genuine, the ASP 204 may ask the consumer 208 (using the browser) whether the consumer 208 is interested to register the product 20. If the consumer 208 provides a positive reply, the ASP 204 would then take the consumer 208 to a registration process to register the product 20 (Step 330). In the registration process, the ASP 204 may ask the consumer 208 to provide information regarding the consumer 208, including one or more of name, address, phone number, contact email address, date of birth, gender, sex, age, marital status, citizenship, etc. After the consumer 208 provides the consumer data, the ASP 204 then updates its database with the consumer data. For example, the ASP 204 may add additional columns (or rows) to the table 400 for different respective types of consumer data (e.g., one column for consumer name, one column for consumer address, etc.). In other embodiments, the product registration is optional, and the method 300 may not include step 330.

It should be noted that the method 300 for authenticating the product 20 using the device 10 is not limited to the embodiments described previously, and that the device 10 may be used to authenticate the product 20 using other techniques. Also, in other embodiments, one or more of the steps in the method 300 may be omitted. Furthermore, in other embodiments, two or more of the steps in the method 300 may be combined. In still other embodiments, the order of the steps in the method 300 may be different from that described. For example, in other embodiments, two or more of the steps may be performed simultaneously.

In the above embodiments, if the product authentication device 10 fails to provide a valid serial number 60 (e.g., the ASP 204 could not find the serial number 60 in its data base), then the ASP 204 may determine that the product 20 is not authentic. The ASP 204 may then send a message indicating that the product serial number 60 is invalid, and/or that the device 10 and/or the product 20 is not authentic. In other embodiments, if the ASP 204 could not verify the serial number 60 received by the ASP 204, the ASP 204 may attempt to read the serial number 60 from the device 10 a second time. If the ASP 204 still could not find the serial number 60 in its data base, then the ASP 204 may determine that the product 20 is not authentic. The ASP 204 may then send a message indicating that the product serial number 60 is invalid, and/or that the device 10 and/or the product 20 is not authentic. In other embodiments, the ASP 204 may attempt to read the product serial number 60 up to a prescribed number that is more than two of times (e.g., five times). Also, in some embodiments, the consumer 208 may be instructed to try to plug the product authentication device 10 to another USB port (or another type of communication connection) or use another internet access device. If all fail, the ASP 204 would then inform the consumer 208 that the product authentication device 10 and/or the product 20 associated therewith is not valid. In such cases, it is likely that the product 20 is not genuine, and the consumer 208 is encouraged to make sure that the product 20 is purchased from a reputable retailer.

Also, in other embodiments, if the product authentication device 10 provides a valid serial number 60, but fails a challenge by the ASP 204, the ASP 204 would attempt to challenge a second time or up to a prescribed number of times (e.g., five times), each time with a different random number. If the device 10 fails all of the challenges by the ASP 204, the ASP 204 would then inform the consumer 208 that the product authentication device 10 and/or the product 20 associated therewith is not valid. In such cases, it is likely that the product 20 is not genuine, and the consumer 208 is encouraged to make sure that the product 20 is purchased from a reputable retailer.

In some cases, after the product authentication device 10 has been used once to determine the authenticity of the product 20, the consumer 208 may use the product authentication device 10 again, and plug it into a computer. In such cases, the ASP 204 would go through the product authentication process again, including reading the serial number 60 from the device 10, and going through the challenge process. If the result of the product authentication process is positive, the ASP 204 would present the product information to the consumer 208 again. If the consumer 208 had registered the product 20 previously, the ASP 204 would remind the consumer 208 that the product 20 had been registered. If not, the ASP 204 would ask the consumer 208 whether the consumer 208 would like to register the product 20.

In the above embodiments, the authentication of the product 20 has been described as involving (1) determining that the serial number 60 from the device 10 is valid, (2) determining that the serial number 60 is associated with a device 10 that is “active,” and (3) determining whether the calculated authentication code 80 matches the reference authentication code 72 (i.e., successfully answering a challenge by the ASP 204). However, in other embodiments, the authentication of the product 20 may not need to include all of these criteria. For example, in other embodiments, the ASP 204 may determine that the product 20 is authentic only when the serial number 60 is valid. In such cases, the act of determining whether the serial number 60 is associated with a device that is “active”, and the acts of determining the reference authentication code 72 and determining the calculated authentication code 80, may be omitted. In further embodiments, the ASP 204 may determine that the product is authentic when the serial number 60 is valid and active. In such cases, the acts of determining the reference authentication code 72 and determining the calculated authentication code 80 may be omitted. In still further embodiments, the ASP 204 may not need to determine whether the serial number 60 from the product authentication device 10 is valid, and may not need to determine whether the device 10 is active during the product authentication process. Instead, the ASP 204 may determine the reference authentication code 72 using the serial number 60 transmitted from the product authentication device and the random number 70. The ASP 204 then transmits the random number 70 to the device 10, which calculates the authentication code 80 using the random number 70 received from the ASP 204 and the serial number 60 stored in the device 10. The device 10 then transmits the calculated authentication code 80 to the ASP 204 so that the ASP 204 can determine whether the calculated authentication code 80 matches the reference authentication code 72.

In addition, in other embodiments, the reference authentication code 72 and the calculated authentication code 80 may be determined using other techniques that are different from the embodiments described previously. For example, in other embodiments, instead of using all of the parameters (i.e., the random number 70, the serial number 60, the secret code 64, and the key 62) to generate the authentication codes 72, 80, the codes 72, 80 may be determined using a subset of the parameters discussed previously. In some embodiments, the authentication codes 72, 80 may be determined by the ASP 204 and the device 10, respectively, using only the random number 70. In other embodiments, the authentication codes 72, 80 may be determined by the ASP 204 and the device 10, respectively, using only the serial number 60 and the random number 70. In still other embodiments, the authentication codes 72, 80 may be determined by the ASP 204 and the device 10, respectively, using only the serial number 60, the random number 70, and the secret code 64. In further embodiments, the authentication codes 72, 80 may be determined by the ASP 204 and the device 10, respectively, using only the secret code 64. In still further embodiments, the authentication codes 72, 80 may be determined by the ASP 204 and the device 10, respectively, using only the random number 70 and the secret code 64. In further embodiments, the authentication codes 72, 80 may be determined by the ASP 204 and the device 10, respectively, using only the key 62 and the secret code 64. In other embodiments, the authentication codes 72, 80 may be determined by the ASP 204 and the device 10, respectively, using any of other possible combinations of the above parameters (or a subset of the above parameters).

Also, in some of the above embodiments, the product authentication device 10 has been described as being used in the store. However, in other embodiments, instead of using the product authentication device 10 in the store, the consumer 208 may use the device 10 at other locations. For example, after the consumer 208 made the purchase, the consumer 208 may take the product 20 and the product authentication device 10 home, and use the product authentication device 10 at home to determine whether the product 20 is authentic. Also, in another example, the product 20 may be purchased by the user online. In such cases, the user may use the product authentication device 10 at home after receiving the product 20 from mail. Also, in other embodiments, instead of using the product authentication device 10 after making the purchase of the product 20, the consumer may use the product authentication device 10 to determine whether the product 20 is genuine before or during making the purchase of the product 20.

Returning to the flow diagram 200 of FIG. 2, in some embodiments, a return envelop (with or without a prepaid postage) may be provided with the product authentication device 10. In such cases, the consumer 208 may recycle the product authentication device 10 by mailing it to a recycling location 210 (which may be a facility of the ASP 204) using the provided envelop (Step 280). In other embodiments, the consumer 208 may simply drop off the device 10 at any of the available recycling locations 210 (which may be a bin at the store, etc.). In some embodiments, at the end of a product authentication process, or after the consumer 208 has registered the product 20, the ASP 204 may transmit a message through the Internet to the computer (the one being used by the consumer 208) to inform the consumer 208 that the device 10 may be recycled, and to provide instruction to the consumer 208 for recycling the device 10.

Upon receiving the recycled product authentication device 10, the ASP 204 or its contract service provider would machine read the serial number 60 from the device 10, and would update its database that the product authentication device 10 is no longer active. In some embodiments, following the example of FIG. 4, the ASP 204 may update the table 400 to indicate that a returned device 10 is no longer active. Also, in some embodiments, the ASP 204 may determine if the consumer 208 who returned the device 10 for recycling is a registered consumer. If the consumer 208 has registered with the ASP 204, and has previously been provided with business incentive (such as rebate, lucky draw, or points), the ASP 204 would then activate the incentive procedure(s) to make sure that the proper incentive goes to the registered consumer 208. For example, in some embodiments, the ASP 204 may contact one or more business entities to inform that the consumer 208 should receive rebate, points, etc., from the business entities.

Next, the recycled device 10 is then electrically tested and visually verified by test machine(s) to make sure that the device 10 is still functioning properly, and that the device 10 meets all production requirements. If the recycled device 10 passes all the tests, the device 10 is then shipped to a product provider 206 for its next authentication use. In some embodiments, information stored in the recycled device 10 may be reprogrammed before the device 10 is sent to a product provider 206. For example, in some embodiments, the secret code 64 in the device 10 may be reprogrammed so that it has a different value from that of the previous use. In other embodiments, if the serial number 60 and the key 62 are reprogrammable, these parameters may also be reprogrammed so that they have different respective values from those of previous use.

If the recycled device 10 fails any of the tests, the ASP 204 or its subcontractor will separate it out, and dispose it according to any applicable local electronic device disposal rules and regulations. The ASP 204 may be configured to update its database to reflect whether a particular product authentication device 10 passes or fails a test. In some embodiments, for a particular product authentication device 10 that fails a test, the ASP 204 may delete the corresponding entries in the table 400 for that particular device 10. In other embodiments, the ASP 204 may update an entry in the table 400 to reflect that the device 10 is inoperable.

As illustrated in the above embodiments, the secret codes 64 and its corresponding product information is paired and stored in a secure database resides in the internet on a cloud computing platform, where it is securely guarded, designed to be fail safe, and accessible anytime by only the user of the product authentication devices 10. Thus, embodiments of the authentication process is advantageous because the ASP 204 that produces and encrypts the devices 10 hosts the database that stores the secret codes, and is independent of the producer of the corresponding product. This ensures data integrity at the ASP 204.

Also, as illustrated in the above embodiments, the authentication technique provides a closed system with multiple unique authentication devices 10 to perform multiple product authentications. In practice, all of the product authentication devices 10 will have unique serial numbers 60 with unique secret codes 64. Thus, it would be useless to duplicate any one or more of them since product authentication is done only one time with one particular product. After the one time valid authentication, the respective product authentication device 10 is taken out of the product authentication service. The secure server of the ASP 204 works with the product authentication devices 10 in a closed system in that nobody else would have access to modify or update the ASP secure server, except the ASP 204 itself.

It should be noted that the service provided by ASP 204 is not limited to product authentication, and that the ASP 204 may provide other services in other embodiments. For example, as discussed, during or after the product authentication process, the ASP 204 may gather information regarding the consumer 208 of the product 20 that is authenticated by the device 10. In some embodiments, the ASP 204 may then use the purchaser information to provide different services for different business entities, such as product providers 206, consumers 208 (e.g., purchasers of the products that are by the devices 10), research and marketing organizations, companies that provide various different local business services, etc.

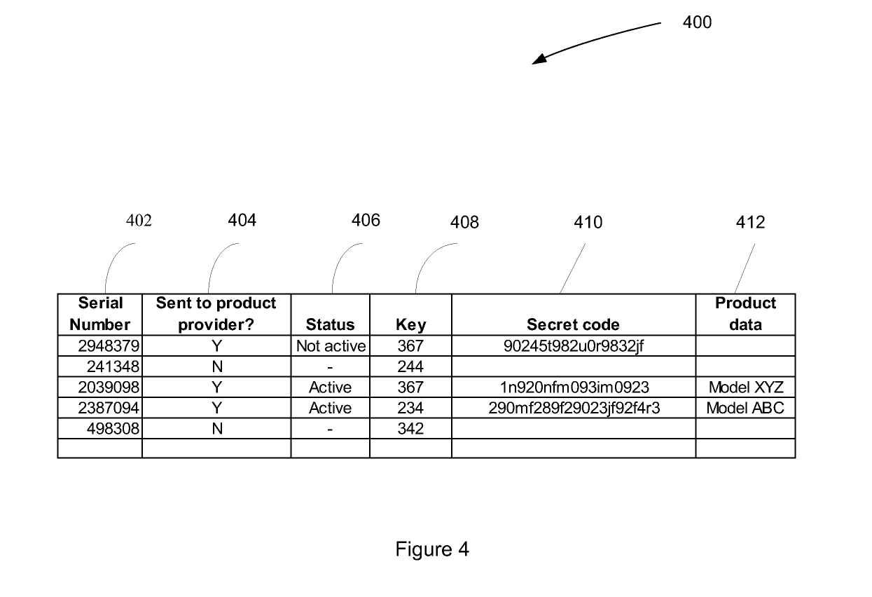

FIG. 5 is a flow diagram illustrating different services that may be provided by the ASP 204 in accordance with some embodiments. In particular, in some embodiments, the ASP 204 may provide different producer services for the manufacturer 202 of the product. Such services may include (1) customer support hosting, (2) up-sell and cross-sell marketing program, (3) recall notification, (4) bulletin notification, (5) installing base business intelligent and consulting, and (6) providing advertisement and promotional programs. In one implementation of the recall notification service, the ASP 204 may receive a request from the manufacturer 202 that a certain model of a product needs to be recalled. In response to such request, the ASP 204 looks up its database to identify all consumers 204 who has ownership of the product with the model. The ASP 204 may provide the data regarding these consumers 204, such as contact info, to the manufacturer 202. In addition, or alternatively, the ASP 204 may contact the consumers 204 to inform them about the recall.

In other embodiments, the ASP 204 may also provide consumer services for end customers 208. Example of such services include (1) product support and warranty, (2) peer-to-peer product support, reviews, and tips, (3) DYI video and information networking, (4) resell support, (5) pool for bulk purchase discount program, 6) deal of the day promotional events, (7) charitable and award events, and (8) choice award promotional program. By means of non-limiting examples, resell support service may include providing proof of ownership, registering owner of product (e.g., receiving and saving ownership info, such as name of owner, date of purchase, etc.), providing ownership history (so that a prospective buyer of the product 20 can see how many owners have owned the product 20, duration of ownership, etc.), providing previous sell info (such as the name of the previous owner(s), location(s), and price(s) of purchase), transferring of ownership (e.g., Pink Slip), and providing lost/stolen service (e.g., providing lost/stolen report).

As discussed, in some embodiments, the ASP 204 may provide resell support for consumers 208. For example, in some cases, a first consumer may buy the product 20 and may keep the device 10 after using it to authenticate the product 20. Later, if the first consumer wants to sell the product 20 to a second consumer, the first consumer may instruct the ASP 204 to release product ownership data to the second consumer. By means of non-limiting examples, such product ownership data may include purchase date, warranty information, price of purchase, previous purchaser's info (such as name, address, contact info, etc.), repair history, etc. In some embodiments, the instructing of the ASP 204 may be performed using the device 10. In such cases, the first consumer may plug the device 10 to a computer through the communication interface 16. In response to the plugging of the device 10 to the computer, the computer launches a browser to access the database of the ASP 204. The ASP 204 provides a user interface (e.g., a web page), which allows the first consumer to request product ownership data be released. In other embodiments, the instructing of the ASP 204 may be performed by the user accessing a web page, or emailing a request to the ASP 204. Once the ASP 204 has received the request from the first consumer to release the product ownership data, the ASP 204 will register such request in its database so that the next time(s) the device 10 is plugged into a computer, the product ownership data will be provided to the computer (e.g., through a web browser) to which the device 10 is plugged. In some embodiments, the ASP 204 may be configured to provide such product ownership data for a prescribed period of time (e.g., 1 week) since the date of the request. In other embodiments, the ASP 204 may provide such product ownership data until the consumer instructs the ASP 204 to stop providing such data.

The second consumer may verify the authenticity of the product 20 using the device 10. In particular, the second consumer may plug the device 10 into a computer, and verify that the product 20 is authentic. In response to the plugging of the device 10 to the computer, the ASP 204 also provides the product ownership data that were authorized to be released previously by the first consumer. This allows the second consumer to see the history of the product 20, including but not limited to, how many owners have owned the product 20, repair history, previous price(s) of purchase, etc. In some cases, if the previous owner(s) has updated the ASP 204 regarding the status of the product 20, such as whether the product 20 has been damaged (e.g., a decorative button has felt out of a luxury handbag), whether the product 20 has been modified, whether a function of the product 20 is no longer working, etc., such status information may be provided to the second consumer. In some embodiments, when an owner updates the ASP 204 with the status of the product 20, the owner may upload a picture and/or a description to the database of the ASP 204, wherein such information is then linked to the specific device 10 that is associated with the product 20.

If the second consumer is satisfied with the information he/she received, the second consumer may buy the product 20 from the first consumer. After the second consumer has purchased the product 20, the first consumer (or the second consumer) may instruct the ASP 204 to register the resell of the product 20. The ASP 204 may charge a service fee, or service points, for such registration. The second consumer then takes the product 20 together with the product authentication device 10. The second consumer may register the product 20 with ASP using the device 10. The ASP 204 then updates its data base to reflect that the second consumer has ownership right of the device 10 and the product 20. For example, the ownership right may be the right to instruct the ASP 204 to release ownership info to another party, such as a third consumer if the second consumer later decides to sell the product 20.

If the second consumer later decides to sell the product 20 to a third consumer, the above process may be repeated.

As illustrated in the above example, the product authentication device 10 may function like a “pink slip” which establishes a person or business as the legal owner of a vehicle, while the ASP 204 provides history report for the product 20, like the service provided by Carfax. Carfax, Inc. is a commercial web-based service that supplies vehicle history reports to individuals and businesses on used cars and light trucks for the American and Canadian market places. Thus, in other embodiments, embodiments of the device 10 and associated method may be used for car purchase.

The above resell support services may also apply to product 20 that is an antique in other embodiments, wherein the next owner of an antique would probably want to know the history of the item. In other embodiments, the above resell support services may also apply to luxury items like handbags, diamond rings, or a baseball signed by famous player. For certain product, who the previous owners are, may be the main selling point of the product. Also, for industrial equipments, certain information like maintenance records, repair history, parts replaced, etc., could greatly affect the selling price of the equipments. Thus, providing such services by the ASP 204 would be very helpful in allowing the current owner of the product 20 to resell the product 20.

As discussed, in some embodiments, the ASP 204 may provide lost/stolen service. For example, in some embodiments, if the product 20 is stolen or lost, the consumer 208 (owner) may report to the ASP 204. If the owner 208 still have the product authentication device 10, the owner 208 may plug the device 10 to a computer to cause a browser to be launched. The owner 208 may then contact the ASP 204 to report the lost/stolen product 20. Alternatively, the owner 208 may send an email to ASP 204. In some cases, the owner 208 may also provide certain information to the ASP 204 for allowing identification of the lost/stolen product 20, such as place at which the product 20 was lost/stolen, whether product 20 has any markings (such as a dent, a scratch, a hand-written text, etc.), and if the product 20 is a handbag, what items are inside the handbag, etc. The ASP 204 updates its database to reflect that the product 20 that corresponds with the device 10 has been lost/stolen. In some cases, if the product 20 is later found, the founder may insert the product authentication device 10, and inform ASP 204 the whereabouts of the product 20. If the device 10 is not coupled to the product 20, the founder may contact the ASP 204 using other techniques, such as by sending the ASP 204 an email, calling ASP 204, or manually launching a browser to access the ASP 204 database. In the situation in which the device 10 is not coupled to the product 20 when found by the founder, the ASP 204 may request the founder to provide certain information, such as where the product 20 was found, whether the product 20 includes any marking(s), and if the product 20 is a handbag, what items are in the handbag. The ASP 204 then searches its database (based on the info provided by the founder) to see if the lost/stolen product 20 matches any of the items that was reported lost/stolen previously. If a match is found, then the ASP may determine that the lost/stolen product 20 has been found.

After determining that the lost/stolen product 20 has been found, the ASP 204 may then relay the info to the rightful owner. In some embodiments, the rightful owner of the product 20 may then contact the founder directly to retrieve the product 20.

In some embodiments, if the product 20 was stolen, and if the thief attempts to sell or has sold the product 20, the buyer or prospective buyer may plug the device 10 to a computer (if the device 10 is still coupled to the product 20). The plugging of the device 10 to the computer will automatically launch a browser, and access the database of the ASP 204, thereby informing the ASP 204 that the device 10 corresponding to a lost/stolen product 20 is being used. The ASP 204 may then cooperate with the authority (e.g., police) to pass any new purchase info to them in case the victim is not aware that the product 20 was lost/stolen.

Referring to FIG. 5, in other embodiments, the ASP 204 may also provide local business services for local business entity 510. Examples of such services include (1) pinpointed marketing and promotional services, (2) product clearance services, and (3) coupon and discount service program.

In still other embodiments, the ASP 204 may also provide business intelligent services for research and marketing organizations 512. Examples of such services include (1) providing multi-dimension business intelligent, and (2) providing geographical and/or demographical focus marketing service.

In any of the embodiments described herein, the purchaser of the product that is authenticated using the product authentication device 10 may have the option to create a user account with the ASP 204. Such may be accomplished at the time when the consumer is authenticating the product, or at a subsequent time after the customer has authenticated the product. In some cases, the consumer who has a user account with ASP 204 can access the ASP's web site to redeem credits, access free and/or subscribed services, access sponsored promotion program, discount program, and/or award program, join peer support group, join social networking, etc.

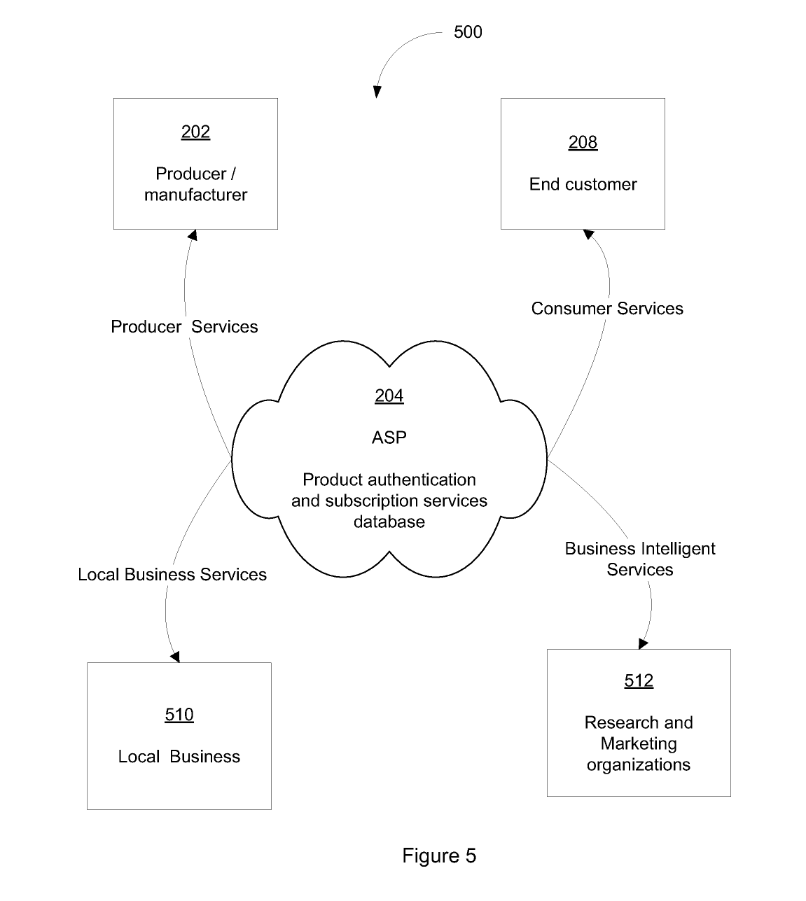

In any of the embodiments of the product authentication device 10 described herein, the product authentication device 10 may further include one or more radiofrequency (RF) interfaces. FIG. 6 illustrates another authentication device 10 in accordance with other embodiments. The device 10 is similar to that described with reference to FIG. 1, except that it further includes a RF interface 600. In the illustrated embodiments, the RF interface 600 includes a RF device (e.g., antenna) configured to transmit and/or receive RF signals. In the illustrated embodiments, in addition to providing product authentication function, the circuit 12 is also configured to provide product identification (RFID) function using the RF interface 600. For example, in some embodiments, the RF interface 600 may transmits a signal (e.g., a tracking signal) to allow a user to locate the device 10 (e.g., in a warehouse, in a store, etc.). In some embodiments, the RFID functionality may be provided using a RFID chip that is integrated into the circuit 12. In other embodiments, the circuit 12 itself may be configured (e.g., built, programmed, etc.) to provide the RFID functionality.

In some embodiments, the RF interface 600 serves the typical RFID tracking function. The context or RFID data may be reprogrammed into the device 10 after each use (e.g., recycle) with programmable non-volatile memory. In some cases, to make reprogrammable faster and reliable, the communication interface 16 may be implemented as a contact interface (such as, a USB interface), which may be used to reprogram the RFID data. In the illustrated embodiments, the RF interface 600 is not used in product authentication because it may be susceptible to unauthorized RF product authentication. However, in other embodiments, the RF interface 600 may be used to perform product authentication as well. It should be noted that the interface 16 is not limited to a USB interface, and that the communication interface 16 may be any of other types of interface, such as an UART interface, a smart card interface, one-wire, etc.

The contact interface makes product authentications secure as the device 10 needs to make physical contact to a device reader (such as a computer) through a communication port (e.g., a standard USB port). In some cases, the programming of both authentication data and RFID data may be done reliably and faster with this contact interface. In other embodiments, the communication interface 16 is not limited to being a contact interface, and may be implemented as a contactless interface (e.g., implemented using a RF device, an optical device, etc.).

In any of the embodiments of the device 10 described herein, the device 10 may be implemented using a USB controller, a crypto-authentication integrated circuit, and a reprogrammable RFID integrated circuit that are electrically coupled together.

In some embodiments, multiple levels of security may be implemented using the device 10. For example, the RFID portion of the device 10 may be used to open a door, while the contact interface 16 of the device 10 may be used to access secure data from the ASP 204.

Also, in some embodiments, the RFID portion of the device 10 may facilitate device 10 production flow at the customer production facility, and transportation of the device 10. For example, at the production facility, a RF reader may be used to pick up the device 10 serial number automatically (e.g., by getting the information through the RF interface 600 of the device 10), and automatically log the production data in a production server data base. In some cases, the production data may then be transferred to the database of the ASP 204 to inform the ASP 204 that the device 10 is ready for use (e.g., ready for coupling to the product 20, ready for sale with the product 20, etc.).

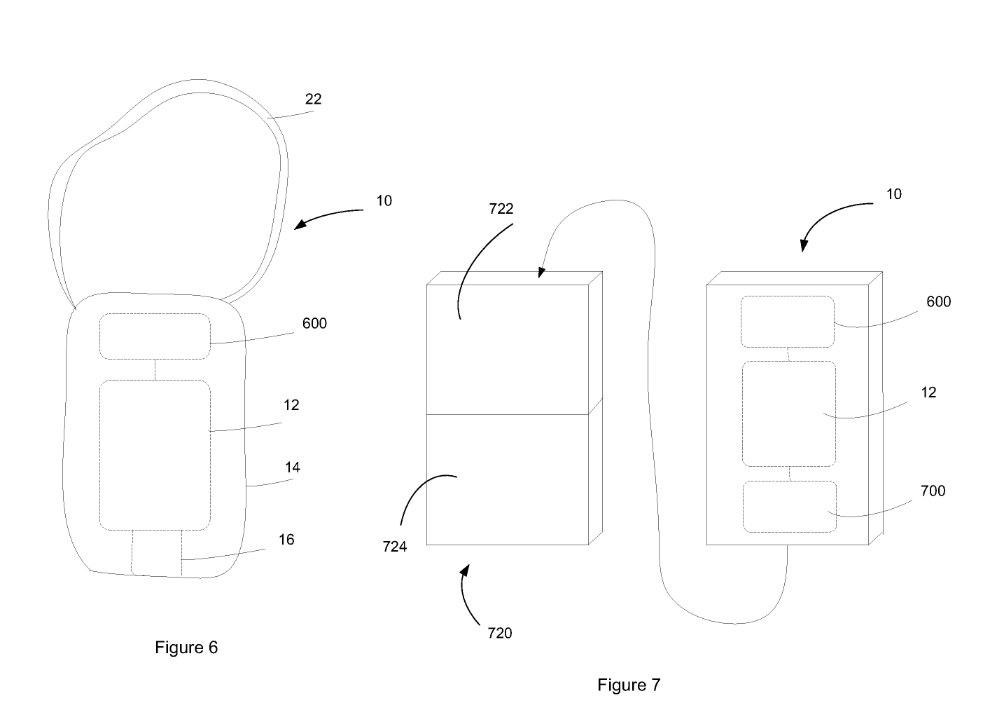

FIG. 7 illustrates another authentication device 10 in accordance with other embodiments. The device 10 is similar to that described with reference to FIG. 6, except that the device 10 is illustrated as having another RF device 700 (e.g., antenna) for the communication interface 16. As similarly discussed, the circuit 12 is configured to provide both product authentication and product identification functionalities. In some embodiments, the circuit 12 may include a RFID chip coupled thereto. In the illustrated embodiments, the antenna 700 is for performing product authentication, and the antenna 600 is for performing RFID function. Also, in some embodiments, the device 10 may optionally include a RF shield 720. The RF shield 720 has a first portion 722 that is transparent to RF signals, and a second portion 724 that blocks RF signals. In some embodiments, the first portion 722 takes up 60% of the area of the shield 720, and the second portion 724 takes up 40% of the area of the shield 720. In other embodiments, the first portion 722 takes up 40% of the area of the shield 720, and the second portion 724 takes up 60% of the area of the shield 720. In further embodiments, the first and second portions 722, 724 may take up different respective percentages of the area of the shield 720 that are different from those discussed previously. In other embodiments, the shield 720 does not have the first portion 722.

When using the device 10 for product authentication, the product authentication device 10 may be taken out from the shield 720, and a device (such as a phone, a PDA, a computer) with a RF reader may be used to communicate with the antenna 700 of the device 10 to perform product authentication in the manner according to the different embodiments described herein. Alternatively, a user may turn the device 10 180° around, and place the device 10 back into the shield 720 so that the antenna 600 is covered by the second portion 724 of the shield 720 to prevent the antenna 600 from communicating to any peripheral device. In such cases, the antenna 700 may still communicate with the reader (e.g., through the first portion 722 of the shield 720 if the shield 720 has the first transparent portion 722).

When using the device 10 for product identification, the product authentication device 10 may be taken out from the shield 720, and a device (such as a phone, a PDA, a computer, a handheld reader, etc.) with a RF reader may be used to communicate with the antenna 600 of the device 10 to perform product identification. Alternatively, a user may turn the device 10 around, and place the device 10 back into the shield 720 so that the antenna 700 is covered by the second portion 724 of the shield 720 to prevent the antenna 700 from communicating to any peripheral device. In such cases, the antenna 600 may still communicate with the reader (e.g., through the first portion 722 of the shield 720 if the shield 720 has the first transparent portion 722).

In some embodiments, during the assembly of the device 10, the antenna 600 for product identification is exposed for communication (e.g., the antenna 600 extends out of the shield 720, or is covered by the first transparent portion 722 of the shield 720 if the shield 720 has the first portion 722), while the antenna 700 is shielded by the second portion 724 of the shield 720. Since the antenna 600 is not RF shielded, the peripheral reader can read the information of the RFID portion of the circuit 12. In such cases, the reader cannot communicate with the PAT since the antenna 700 is shielded by the shield 720.

Computer System Architecture

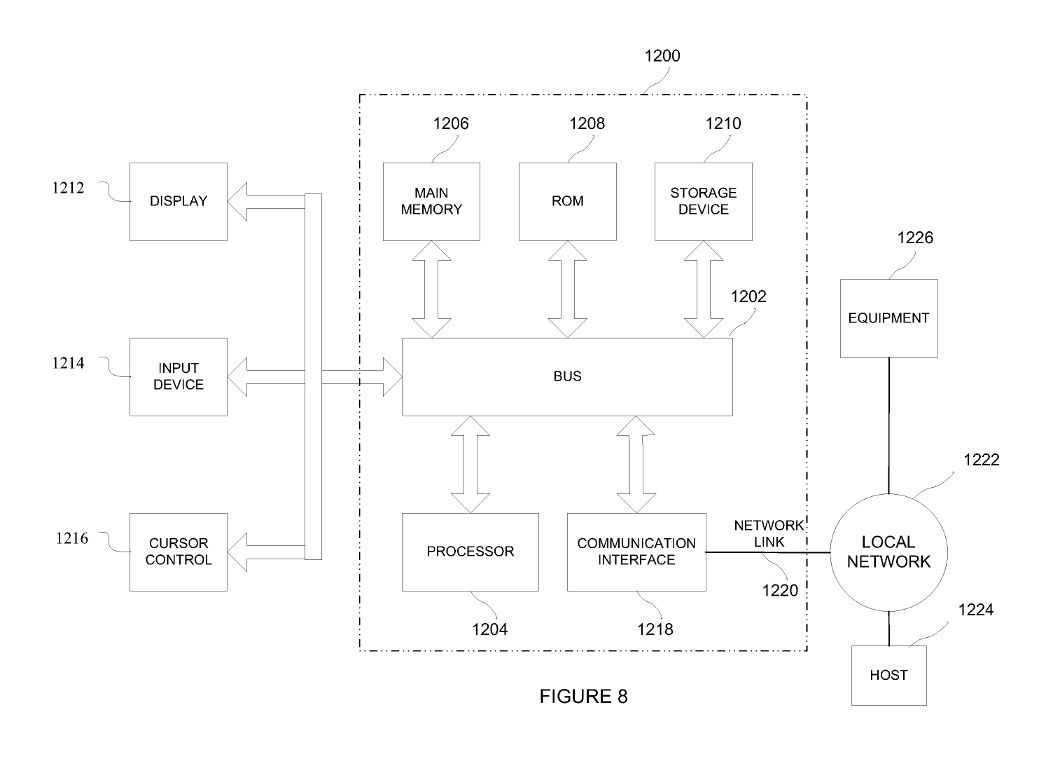

FIG. 8 is a block diagram that illustrates an embodiment of a computer system 1200 upon which embodiments of the ASP 204 may be implemented. In particular, the computer system 1200 may be a part of the database/server for the ASP 204. In other embodiments, the computer system 1200 may be used to implement the computer that is used by the consumer 208 to authenticate the product 20 (i.e., the computer system 1200 may be the computer to which the consumer 208 plug the product authentication device 10).

Computer system 1200 includes a bus 1202 or other communication mechanism for communicating information, and a processor 1204 coupled with the bus 1202 for processing information. The processor 1204 may be an example of the processor that is used to perform various functions described herein. The computer system 1200 also includes a main memory 1206, such as a random access memory (RAM) or other dynamic storage device, coupled to the bus 1202 for storing information and instructions to be executed by the processor 1204. The main memory 1206 also may be used for storing temporary variables or other intermediate information during execution of instructions to be executed by the processor 1204. The computer system 1200 further includes a read only memory (ROM) 1208 or other static storage device coupled to the bus 1202 for storing static information and instructions for the processor 1204. A data storage device 1210, such as a magnetic disk or optical disk, is provided and coupled to the bus 1202 for storing information and instructions.

The computer system 1200 may be coupled via the bus 1202 to a display 1212, such as a cathode ray tube (CRT), for displaying information to a user. An input device 1214, including alphanumeric and other keys, is coupled to the bus 1202 for communicating information and command selections to processor 1204. Another type of user input device is cursor control 1216, such as a mouse, a trackball, or cursor direction keys for communicating direction information and command selections to processor 1204 and for controlling cursor movement on display 1212. This input device typically has two degrees of freedom in two axes, a first axis (e.g., x) and a second axis (e.g., y), that allows the device to specify positions in a plane.

The computer system 1200 may be used for performing various functions (e.g., calculation) in accordance with the embodiments described herein. According to one embodiment, such use is provided by computer system 1200 in response to processor 1204 executing one or more sequences of one or more instructions contained in the main memory 1206. Such instructions may be read into the main memory 1206 from another computer-readable medium, such as storage device 1210. Execution of the sequences of instructions contained in the main memory 1206 causes the processor 1204 to perform the process steps described herein. One or more processors in a multi-processing arrangement may also be employed to execute the sequences of instructions contained in the main memory 1206. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to the processor 1204 for execution. Such a medium may take many forms, including but not limited to, non-volatile media, volatile media, and transmission media. Non-volatile media includes, for example, optical or magnetic disks, such as the storage device 1210. A non-volatile medium is an example of a non-transitory medium. Volatile media includes dynamic memory, such as the main memory 1206. A volatile medium is another example of a non-transitory medium. Transmission media includes coaxial cables, copper wire and fiber optics, including the wires that comprise the bus 1202. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer-readable media may be involved in carrying one or more sequences of one or more instructions to the processor 1204 for execution. For example, the instructions may initially be carried on a magnetic disk of a remote computer. The remote computer can load the instructions into its dynamic memory and send the instructions over a telephone line using a modem. A modem local to the computer system 1200 can receive the data on the telephone line and use an infrared transmitter to convert the data to an infrared signal. An infrared detector coupled to the bus 1202 can receive the data carried in the infrared signal and place the data on the bus 1202. The bus 1202 carries the data to the main memory 1206, from which the processor 1204 retrieves and executes the instructions. The instructions received by the main memory 1206 may optionally be stored on the storage device 1210 either before or after execution by the processor 1204.

The computer system 1200 also includes a communication interface 1218 coupled to the bus 1202. The communication interface 1218 provides a two-way data communication coupling to a network link 1220 that is connected to a local network 1222. For example, the communication interface 1218 may be an integrated services digital network (ISDN) card or a modem to provide a data communication connection to a corresponding type of telephone line. As another example, the communication interface 1218 may be a local area network (LAN) card to provide a data communication connection to a compatible LAN. Wireless links may also be implemented. In any such implementation, the communication interface 1218 sends and receives electrical, electromagnetic or optical signals that carry data streams representing various types of information.

The network link 1220 typically provides data communication through one or more networks to other devices. For example, the network link 1220 may provide a connection through local network 1222 to a host computer 1224 or to equipment 1226 such as a radiation beam source or a switch operatively coupled to a radiation beam source. The data streams transported over the network link 1220 can comprise electrical, electromagnetic or optical signals. The signals through the various networks and the signals on the network link 1220 and through the communication interface 1218, which carry data to and from the computer system 1200, are exemplary forms of carrier waves transporting the information. The computer system 1200 can send messages and receive data, including program code, through the network(s), the network link 1220, and the communication interface 1218.

Although particular embodiments have been shown and described, it will be understood that they are not intended to limit the present inventions, and it will be obvious to those skilled in the art that various changes and modifications may be made without departing from the spirit and scope of the present inventions. The specification and drawings are, accordingly, to be regarded in an illustrative rather than restrictive sense. The present inventions are intended to cover alternatives, modifications, and equivalents, which may be included within the spirit and scope of the present inventions as defined by the claims.

What is claimed:

1. A product authentication device for use with a consumer product, comprising:
an integrated circuit;
a housing containing the integrated circuit;
a coupling mechanism for detachably coupling the housing to the consumer product; and
a communication interface for receiving an input from a transmitting device;
wherein the integrated circuit is configured to use the input to generate an output in accordance with a predetermined algorithm for verifying an authenticity of the consumer product.

2. The device of claim 1, wherein the communication interface comprises a USB connector.

3. The device of claim 2, wherein the integrated circuit is configured to automatically access a webpage in response to the USB connector being inserted into a USB port of the transmitting device.

4. The device of claim 3, wherein the integrated circuit is configured to receive the input from the webpage.

5. The device of claim 1, wherein the input comprises a random number.

6. The device of claim 1, wherein the integrated circuit comprises an authentication chip.

7. The device of claim 6, wherein the integrated circuit further comprises a microcontroller chip.

8. The device of claim 7, wherein the microcontroller chip is coupled between the authentication chip and the communication interface.

9. The device of claim 6, wherein the authentication chip comprises a AT88SA102S chip.

10. The device of claim 6, wherein the authentication chip comprises a unique serial number.

11. The device of claim 10, wherein the unique serial number is 47 bits long.

12. The device of claim 10, wherein the unique serial number cannot be reprogrammed.

13. The device of claim 1, wherein the integrated circuit comprises a serial number, and is configured to use the input and the serial number to generate the output in accordance with the predetermined algorithm for verifying the authenticity of the consumer product.

14. The device of claim 1, wherein the integrated circuit comprises a serial number and a secret code programmed therein, and wherein the integrated circuit is configured to use the input, the serial number, and the secret code to generate the output in accordance with the predetermined algorithm for verifying the authenticity of the consumer product.

15. A product authentication device, comprising:
an integrated circuit;
a housing containing the integrated circuit;
a coupling mechanism for detachably coupling the housing to the consumer product; and
a communication interface for communication with a data source;
wherein the integrated circuit is configured to generate an output in accordance with a predetermined algorithm for verifying an authenticity of the consumer product.

16. The device of claim 15, wherein the communication interface comprises a USB connector.

17. The device of claim 16, wherein the integrated circuit is configured to automatically access a webpage from the data source in response to the USB connector being inserted into a USB port.

18. The device of claim 17, wherein the integrated circuit is configured to receive an input from the webpage.

19. The device of claim 18, wherein the input comprises a random number.

20. The device of claim 15, wherein the integrated circuit comprises an authentication chip.

21. The device of claim 20, wherein the integrated circuit further comprises a microcontroller chip.

22. The device of claim 21, wherein the microcontroller chip is coupled between the authentication chip and the communication interface.

23. The device of claim 20, wherein the authentication chip comprises a AT88SA102S chip.

24. The device of claim 20, wherein the authentication chip comprises a unique serial number.

25. The device of claim 24, wherein the unique serial number is 47 bits long.

26. The device of claim 24, wherein the unique serial number cannot be reprogrammed.

27. The device of claim 15, wherein the integrated circuit comprises a serial number, and is configured to use the serial number to generate the output in accordance with the predetermined algorithm for verifying the authenticity of the consumer product.

28. The device of claim 15, wherein the integrated circuit comprises a serial number and a secret code programmed therein, and wherein the integrated circuit is configured to use the serial number and the secret code to generate the output in accordance with the predetermined algorithm for verifying the authenticity of the consumer product.

29. The device of claim 1, further comprising an additional communication interface coupled to the circuit.

30. The device of claim 29, wherein the communication interface comprises a USB interface, and the additional communication interface comprises a RF device.

31. The device of claim 29, wherein the communication interface comprises a first RF device, and the additional communication interface comprises a second RF device.

32. The device of claim 31, further comprising a shield for covering at least a portion of the housing, the shield having a first portion for blocking RF signal, and a second portion through which the RF signal can transmit therethrough.

33. The device of claim 32, wherein the second portion is larger than the first portion.

34. The device of claim 29, wherein the additional communication interface is configured for providing a tracking signal.

35. A method for verifying an authenticity of a consumer product, comprising:
providing a module with a consumer product, the module being detachably coupled to the consumer product;
using the module to access a web page to obtain an input; and
using the input to generate an output in accordance with a predetermined algorithm for verifying the authenticity of the consumer product.

36. The method of claim 35, wherein the module comprises a serial number stored therein, and the output is generated using the input and the serial number.

37. The method of claim 36, wherein the module further comprises a secret code stored there, and the output is generated using the input, the serial number, and the secret code.

38. The method of claim 35, further comprising transmitting the output to a database.

39. The method of claim 38, further comprising receiving information regarding the consumer product after the database has processed the output to verify the authenticity of the consumer product.

40. The method of claim 39, wherein the information regarding the consumer product comprises one or more of product support information, warranty information, reviews for the consumer product, tips for the consumer product, purchase history for the consumer product.

41. The method of claim 38, further comprising receiving marketing information after the database has processed the output to verify the authenticity of the consumer product.

42. The method of claim 41, wherein the marketing information comprises one or more of bulk purchase discount program, charitable event, award event, deal of the day promotional program, and choice award promotional program.

43. A product authentication device for use with a consumer product, comprising:
a circuit configured to provide information for determining an authenticity of the consumer product;
a housing containing the circuit;
a first communication interface coupled to the circuit;
a second communication interface for providing a tracking signal; and
a shield for covering at least a portion of the housing, the shield having a first portion for blocking RF signal, and a second portion through which the RF signal can transmit therethrough.

44. The device of claim 43, wherein the first communication interface comprises a USB interface, and the second communication interface comprises a RF device.

45. The device of claim 43, wherein the first communication interface comprises a first RF device, and the second communication interface comprises a second RF device.

46. The device of claim 43, wherein the second portion is larger than the first portion.
